(19) United States
(12) Patent Application Publication
(10) Pub. No.: US 2013/0031300 A1
(43) Pub. Date: Jan. 31, 2013

(54) NON-VOLATILE MEMORY DEVICE, METHOD OF OPERATING THE SAME, AND MEMORY SYSTEM HAVING THE NON-VOLATILE MEMORY DEVICE

(71) Applicants: Jeong-Beom Seo, Seoul (KR); Min Wook Jung, Busan (KR); Jin Kyu Kim, Seoul (KR); Eok Soo Shim, Suwon-si (KR)

(72) Inventors: Jeong-Beom Seo, Seoul (KR); Min Wook Jung, Busan (KR); Jin Kyu Kim, Seoul (KR); Eok Soo Shim, Suwon-si (KR)

(21) Appl. No.: 13/475,243

(22) Filed: May 18, 2012

(30) Foreign Application Priority Data
May 19, 2011 (KR) 10-2011-0047369

(51) Int. Cl. G06F 12/02

(52) U.S. Cl. 711/103; 711/E12.008

(57) ABSTRACT

According to an aspect of the inventive concepts, there is provided a non-volatile memory device including a memory array with at least one stripe. The at least one stripe includes at least one parity page and at least one data page. The non-volatile memory device further includes a chip controller. The chip controller includes an operation module configured to perform an operation on data input from the outside of the memory device, to store a result of the performing, and to program the result of the performing into the at least one parity page. The chip controller further includes a data buffer configured to store the input data and to program the input data into the at least one data page.

### CROSS-REFERENCE TO RELATED APPLICATIONS

This application claims the benefit of Korean Patent Application No. 10-2011-0047369, filed on May 19, 2011, in the Korean Intellectual Property Office, the disclosure of which is incorporated herein in its entirety by reference.

### BACKGROUND

The inventive concepts relate to a non-volatile memory device, and/or a method of operating the non-volatile memory device, and/or a memory system having the non-volatile memory device.

Semiconductor memory devices may be classified as either volatile memory devices or non-volatile memory devices.

Examples of volatile memory devices may include dynamic random access memory (DRAM), static random RAM (SRAM), and the like. Examples of non-volatile memory devices may include flash memory, electrically erasable programmable read-only memory (EEPROM), resistive memory, and the like.

The flash memory includes a memory cell array to store data. The memory cell array includes a plurality of memory blocks each including a plurality of pages.

The flash memory performs an erase operation in units of memory blocks, and performs a program operation or a read operation in units of pages.

### SUMMARY

According to an aspect of the inventive concepts, there is provided a non-volatile memory device including a memory array with at least one stripe. The at least one stripe includes at least one parity page and at least one data page. The non-volatile memory device further includes a chip controller. The chip controller includes an operation module configured to perform an operation on data input from the outside of the memory device, to store a result of the performing, and to program the result of the performing into the at least one parity page. The chip controller further includes a data buffer configured to store the input data and to program the input data into the at least one data page.

In some example embodiments, the chip controller may further be configured to store new data input from outside the memory device in the operation module and the data buffer. The chip controller may further be configured to program only the new data stored in the data buffer into the at least one data page.

In some example embodiments, if an operation command is received from a host, then the chip controller may be configured to store a result of performing the operation on first data stored in the operation module and second data input after the first data is input to in the operation module.

In some example embodiments, the first data and the second data are sequentially input from outside the memory device.

In some example embodiments, the memory array may include a plurality of blocks, each of the plurality of blocks including a plurality of pages. Each of the plurality of blocks may include one stripe.

In some example embodiments, the memory array may include a plurality of blocks, each block including a plurality of pages. A first block of the plurality of blocks may include a data page of a first stripe. A second block of the plurality of blocks may include a parity page of the first stripe and a data page of the first stripe. A third block of the plurality of blocks may include a parity page of a second stripe and a data page of a third stripe.

In some example embodiments, the memory array may include a plurality of blocks, each of the plurality of blocks including a plurality of pages. At least two blocks of the plurality of blocks may share a data page and a parity page of one stripe.

In some example embodiments, one of the at least two blocks may include the parity page of the stripe, and the other of the at least two blocks may include the data page of the stripe.

In some example embodiments, the chip controller may be configured to initialize the operation module if an error occurs in a data page of the at least one data page of the memory array. The chip controller may determine a stripe corresponding to the data page containing the error. The chip controller may control the operation module to perform an operation on the at least one parity page of the determined stripe and on the data pages of the determined stripe that do not contain the error. The chip controller may store a result of the performing.

In some embodiments, the chip controller may correct the data page containing the error by using the result of the performing.

In some embodiments, the chip controller may determine at least one data page containing an error. The chip controller may correct the error in the at least one data page based on an error correction code.

In some embodiments, there is provided a non-volatile memory system. The system may include a non-volatile memory device and a memory controller. The memory controller may exchange data with the non-volatile memory device and provide a command received from a host to the non-volatile memory device.

According to another aspect of the inventive concepts, there is provided a method of operating a non-volatile memory device. The method may include receiving first data from outside the non-volatile memory device. The method may further include storing the first data in an operation module and a data buffer included in the non-volatile memory device. The method may further include performing an operation on the first data stored in the operation module and second data received subsequent to receiving the first data. The method may further include storing a first result of the performing in the operation module.

The method of operating a non-volatile memory device may further include receiving third data, performing the operation on the third data and the first result of the performing stored in the operation module, and updating the operation module with a result of the performing the operation on the third data and the first result of the performing.

The method of operating a non-volatile memory device may further include programming the first stored result of the performing into at least one parity page, and programming the first data and the second data into at least one data page.

The method of operating a non-volatile memory device may further include further comprising transmitting the first result of the performing to the data buffer and programming the first result of the performing into the at least one parity page.

The method of operating a non-volatile memory device may further include determining whether an error is correctable using error correct code (ECC) if the error occurs in a data page of the at least one data page. The method may further include determining a stripe corresponding to the data page containing the error. The method may further include performing an operation on the at least one parity page of the determined stripe and on the data pages of the determined stripe that do not contain the error if the determining determines that the error is not correctable using the ECC. The method may further include storing a result of the performing. The method may further include correcting the data page containing the error by using the result of the performing.

In some example embodiments, there is provided a non-volatile memory device. The non-volatile memory device may include a memory array. The memory array may include at least one set of data pages and at least one parity page for the at least one set of data pages. The non-volatile memory device may include an engine configured to calculate parity and to store parity in the at least one parity page.

In some example embodiments, the non-volatile memory device may include a chip controller. The chip controller may be configured to perform an operation on data input from outside the memory device. The chip controller may further be configured to store input data in a data buffer. The chip controller may further be configured to program the input data into the at least one data page.

In some example embodiments, the chip controller may be configured to determine a set of data pages corresponding to a data page containing an error. The chip controller may further be configured to perform an operation on the at least one parity page of the determined set of pages and on the data pages of the determined set of pages that do not contain the error. The chip controller may further be configured to store a result of the performing. The chip controller may further be configured to correct the error based on the result of the performing.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a non-volatile memory system according to an embodiment of the inventive concepts;

FIG. 2 is a diagram schematically illustrating a relationship between an operation module and a memory array, according to an embodiment of the inventive concepts;

FIG. 3 is a diagram schematically illustrating an operation performed in the operation module of FIG. 2, according to an embodiment of the inventive concepts;

FIG. 4 is a diagram schematically illustrating the inside of a memory array, according to an embodiment of the inventive concepts;

FIG. 5 is a diagram illustrating locations of parity pages stored, according to an embodiment of the inventive concepts;

FIG. 6 is a diagram illustrating locations of parity pages stored, according to another embodiment of the inventive concepts;

FIG. 7 is a flowchart illustrating a method of operating a non-volatile memory device, according to an embodiment of the inventive concepts;

FIG. 8 is a flowchart illustrating a method of operating a non-volatile memory device, according to another embodiment of the inventive concepts; and

FIG. 9 through FIG. 12 illustrate nonvolatile memory systems including the memory device according to some embodiments of the inventive concepts, respectively.

### DETAILED DESCRIPTION OF THE EMBODIMENTS

Example embodiments will be described more fully hereinafter with reference to the accompanying drawings, in which example embodiments are shown. Example embodiments may, however, be embodied in many different forms and should not be construed as limited to the embodiments set forth herein. Rather, example embodiments are provided so that this disclosure will be thorough and complete, and will fully convey the scope of example embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

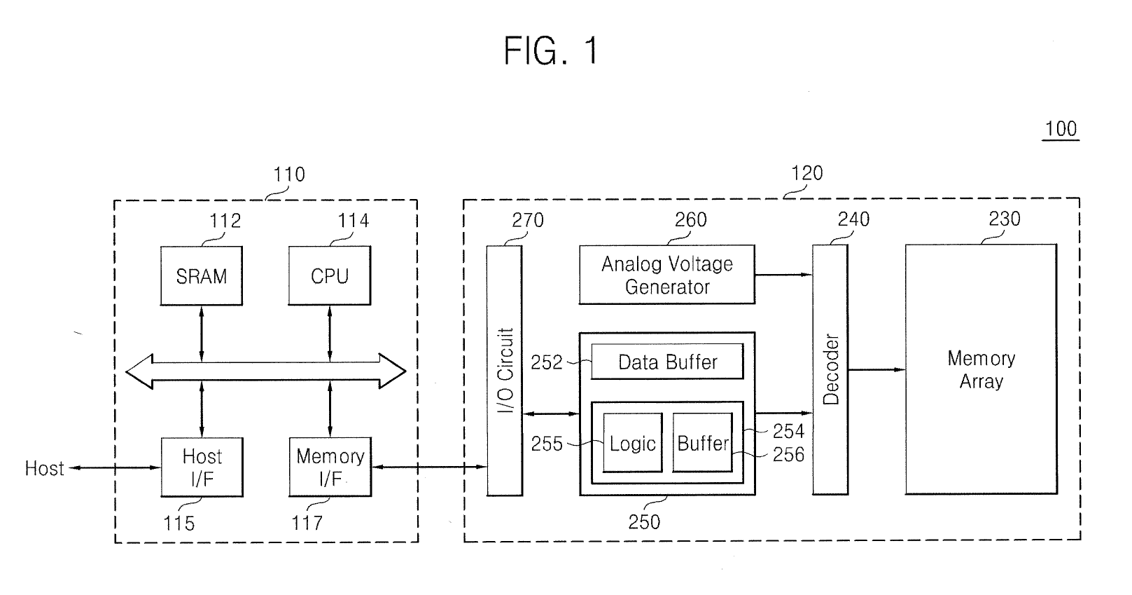

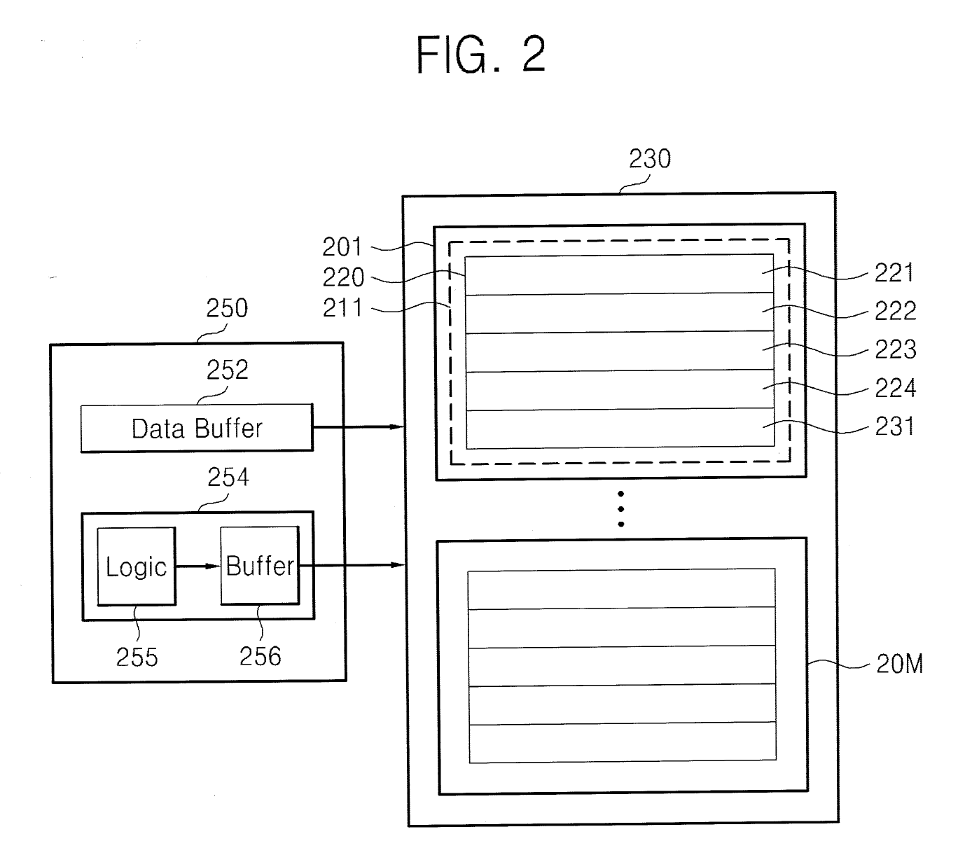

FIG. 1 is a block diagram of a non-volatile memory system 100 according to an embodiment of the inventive concepts. FIG. 2 is a diagram schematically illustrating a relationship between an operation module 254 and a memory array 230, according to an embodiment of the inventive concepts.

Referring to FIGS. 1 and 2, the non-volatile memory system 100 (hereinafter referred to as the memory system 100) may include a memory controller 110 and a non-volatile memory device 120 (hereinafter referred to as the memory device 120).

The memory device 120 may include the memory array 230, a decoder 240, a chip controller 250, an analog voltage generator 260, and an input/output (I/O) circuit 270.

The memory controller 110 may include a static random access memory (SRAM) 112, a central processing unit (CPU) 114, a host interface (I/F) 115, and a memory I/F 117. The SRAM 112, the CPU 114, the host I/F 115, and the memory I/F 117 may be connected via a bus to exchange data with one another.

The SRAM 112 may temporarily store a program run by the CPU 114. The CPU 114 may control the elements of the memory controller 110.

The host I/F 115 provides an interface for communicating between a host (not shown) and the CPU 114, under control of the CPU 114. For example, the host I/F 115 may be an advanced technology attachment (ATA) interface, a serial ATA interface, a parallel ATA interface, or a small computer system interface (SCSI).

The memory I/F 117 provides an interface for communicating between the CPU 114 and the memory device 120, under control of the CPU 114. If the memory device 120 is embodied as NAND flash memory, the memory I/F 117 may be a NAND flash memory I/F.

Here, the term ‘I/F’ means hardware or firmware-embedded hardware for implementing a data communication interface.

Although not shown, the memory controller 110 may further include a read-only memory (ROM). The ROM may store a program run by the CPU 114. For example, the ROM may store a program for controlling or managing the host I/F 115 or the memory I/F 117.

The memory array 230 may include a plurality of blocks 201 to 20M, where (M denotes a natural number. Each of the plurality of blocks 201 to 20M is a minimum unit of non-volatile memory cells from which a plurality of pieces of stored data are erased in a single erase operation. Each of the plurality of blocks 201 to 20M includes a plurality of pages, and each of the plurality of pages includes a plurality of non-volatile memory cells. Each of the plurality of non-volatile memory cells may be a NAND flash memory capable of storing at least two bits of data.

The memory device 120 may be implemented with, for example, Electrically Erasable Programmable Read-Only Memory (EEPROM), flash memory, Magnetic RAM (MRAM), Spin-transfer Torque MRAM, Conductive bridging RAM (CBRAM), Ferroelectric RAM (FeRAM), Phase change RAM (PRAM), Resistive RAM (RRAM or ReRAM), Nanotube RRAM, Polymer RAM (PoRAM), Nano Floating Gate Memory (NFGM), holographic memory, Molecular Electronics Memory Device, or Insulator Resistance Change Memory.

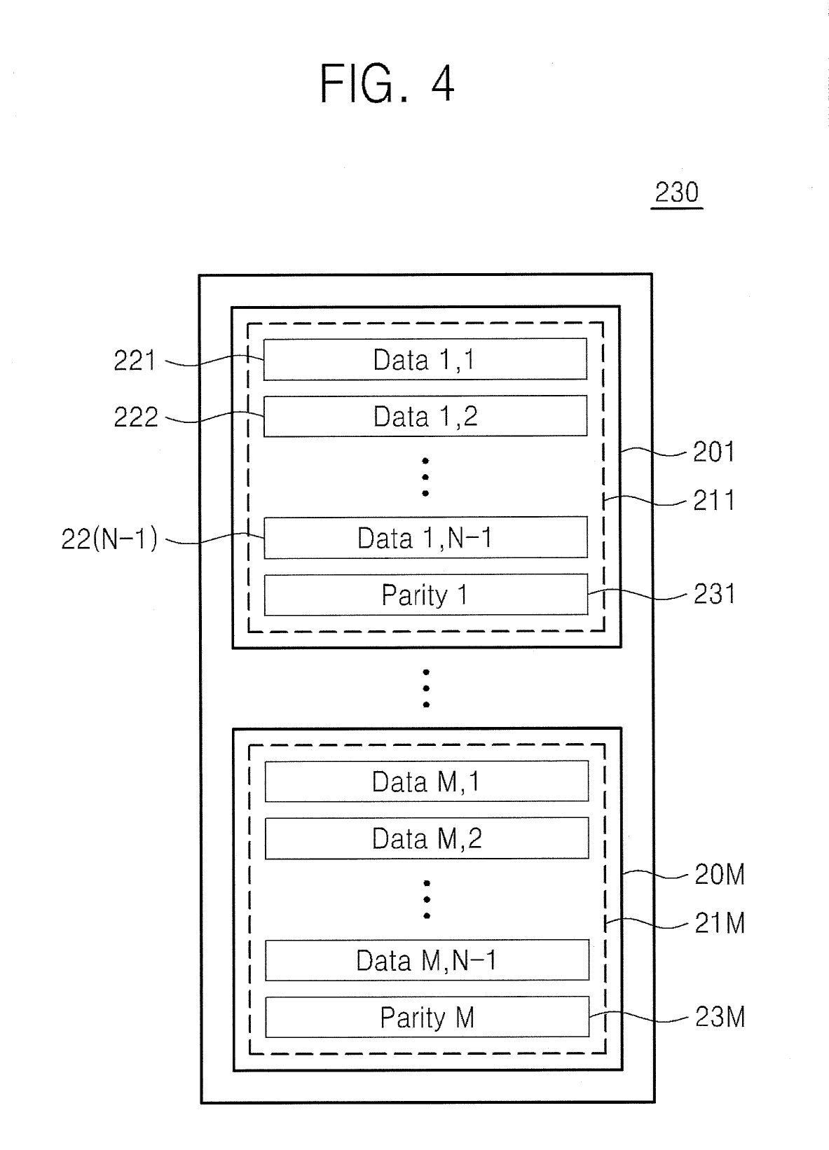

Blocks, parity pages, data pages, and stripes in a memory array according to an embodiment of the inventive concepts will be described in detail with reference to FIGS. 4 to 6 below.

The decoder 240 may select a word line from the memory array 230 when a program operation, a read operation, or an erase operation is performed on the non-volatile memory device 120, under control of the chip controller 250. That is, a word line may be selected from among a plurality of word lines based on row addresses, a first operating voltage may be applied to the selected word line, and a second operating voltage may be applied to the remaining word lines.

For example, in a program mode, the decoder 240 may apply the first operating voltage, e.g., a program voltage, to the selected word line and the second operating voltage, e.g., a pass voltage, to the remaining word lines. In a read mode, the decoder 240 may apply the first operating voltage, e.g., a ground voltage, to the selected word line and the second operating voltage, e.g., a read voltage, to the remaining word lines.

The controller 250 may output control signals for controlling operations of the memory device 120, e.g., the program operation, the erase operation, and the read operation, in response to a command received from the outside.

The chip controller 250 may include a data buffer 252 and the operation module 254. The operation module 254 may include an operation unit 255 and a storage unit 256. The operation module 254 and the data buffer 252 may not be implemented in the chip controller 250, and may instead be respectively implemented elsewhere in the memory device 120. In other words, the operation module 254 is not limited to residing inside the chip controller 250, and the operation module 254 may be included elsewhere in the memory device 120 where the operation module 254 may operate under the control of the chip controller 250.

Within the operation module 254, the operation unit 255 may perform an operation on data received from the outside and the storage unit 256 may store a result of performing the operation on the data received from the outside. The operation module 254 may program a result of performing an operation. The result of performing the operation may be stored in a parity page 231 of a stripe 211. It should be understood that the parity may be calculated by an engine. The operation performed by the operation module 254 may be, for example, an XOR operation.

The data buffer 252 may store data received from outside the memory device 120, and the data buffer 252 may program the received data into data pages 221 to 224 of stripe 211.

When new data is received from outside the memory device 120, the chip controller 250 may input the new data to both the operation module 254 and the data buffer 252, and the chip controller 250 may program only the new data input to the data buffer 252 into the data pages 221 to 224.

The stripe 211 may include at least two pages, and the stripe 211 may be a set of pages 220 that share parity stored in the parity page 231. In detail, the parity page 231 and the data pages 221 to 224 constitute the same stripe 211. A parity that is a result of performing the XOR operation on data stored in the data pages 221 to 224 that share the same stripe 211 may be stored in the parity page 231.

The XOR operation may be performed by the operation unit 255 of the operation module 254, and a parity that is a result of performing the XOR operation may be stored in the parity page 231. Even if an error occurs in one of the data pages 221 to 224, the error may be corrected by using a result of programming the parity.

Each of the blocks 201 to 20M is a minimum unit of memory cells from which data is erased by performing a single erase operation. Each of the blocks 201 to 20M has a physical size. On the other hand, the stripe 211 has a logical size, the logical size signifying a set of pages sharing one parity page regardless of the total number of pages included in the stripe 211.

In other words, when data is first written to the chip controller 250, only the data is stored in both the data buffer 252 and the operation module 254. In this case, because no previously-stored data is present in the operation module 254, the XOR operation is not performed on the data stored in the operation module 254.

In this case, the data stored in the operation module 254 is not programmed into the memory array 230 and the data stored in the data buffer 252 may be programmed into the data page 221 of the memory array 230.

The chip controller 250 may control whether to input data to the operation module 254, in response to an input received from the host.

If an operation command is received from the host, then a result of performing the operation on first data being previously stored in the operation module 254 and second data input to the operation module 254 after the first data was input thereto may be stored in the operation module 254, the first data and the second data being data from among a plurality of pieces of data that are sequentially input from outside the memory device 120. The second data may be input immediately subsequent to or at a time interval after the first data was input.

The chip controller 250 may, for example, program the result of the performing stored in the operation module 254 into the parity page 231 of the memory array 230 or the chip controller 250 may move the result of the performing stored in the data buffer 252 to the data buffer 252 and program the result of the performing stored in the data buffer 252 into the parity page 231. However, the inventive concepts are not limited thereto.

If no operation command instructing performance of the XOR operation on particular data is received from the host, the chip controller 250 may control data to be input to the data buffer 252 and program the input data into the memory array 230.

The analog voltage generator 260 may generate, for example, a program voltage, a pass voltage, and a read voltage needed to operate the memory device 120.

The I/O circuit 270 may act as an interface with the outside, i.e., the memory controller 110. Specifically, the I/O circuit 270 may receive a command and data to be programmed from the outside, and transmit a status signal and read data to the outside.

The memory controller 110 may control exchange of all data between the host and the memory device 120. For example, the memory controller 110 may control the memory device 120 to write or read data, under control of the host.

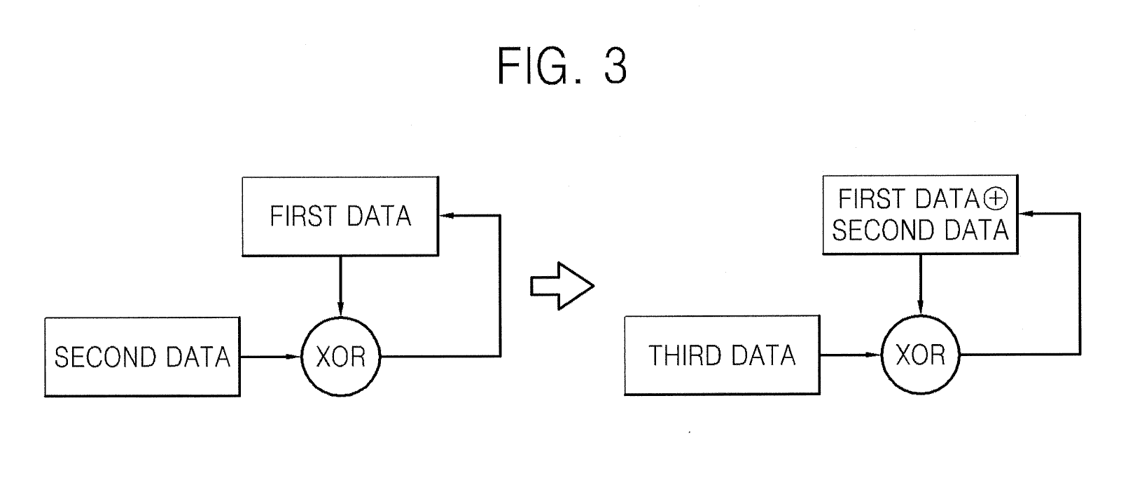

FIG. 3 is a diagram schematically illustrating an operation performed in the operation module 254 of FIG. 2, according to an embodiment of the inventive concepts. First data that is first input data is stored in the storage unit 256 of the operation module 254. Then, when second data is input, the operation unit 255 may perform the XOR operation on the first data and the second data and store a result of the performing in the storage unit 256.

When third data is input after the second data was input, the operation unit 255 may perform the XOR operation on the result of the performing stored in the storage unit 256 and the third data, and the operation unit 255 may store a result of the performing in the storage unit 256. In other words, if new data is input to the operation module 254 and the XOR operation is performed on the new data and a stored result of performing the XOR operation, then the operation unit 255 may update the stored result of the performing stored in the storage unit 256.

The first, second, and third data may be sequentially input, or other data may be input between the first data and the second data, or other data may be input between the second data and the third data.

FIG. 4 is a diagram schematically illustrating the memory array 230 of FIG. 1, according to an embodiment of the inventive concepts. In other words, FIG. 4 illustrates a technique of managing parities in the memory device 120 of FIG. 1. Referring to FIG. 4, the memory array 230 may include at least one stripe, e.g., stripes 211 to 21M, which each includes at least one parity page, e.g., parity pages 231 to 23M, and at least one data page, e.g., data pages 221 to 22(N−1). Here, ‘M’ denotes a natural number and ‘N’ denotes a natural number that is equal to or greater than ‘2’.

The memory array 230 may include a plurality of blocks 201 to 20M. Each of the plurality of blocks 201 to 20M may include the data pages 221 to 22(N−1) for storing data, and the parity page 231 for storing parity that is calculated and written to the parity page 231 by the operation module 254.

According to an embodiment of the inventive concepts, in the memory array 230 of FIG. 4, the plurality of blocks 201 to 20M respectively include the stripes 211 to 21M. In other words, referring to FIG. 4, each of the plurality of blocks 201 to 20M and the stripes 211to 21M corresponding thereto includes the same page.

In detail, if the M blocks 201 to 20M are present in the memory device 120 and an I^{th} block from among the M blocks 201 to 20M is the block 201, then the N data pages 221 to 22(N−1) may be present in the I^{th} block 201 and data contained in a J^{th} page from among the N data pages 221 to 22(N−1) may be expressed with ‘Data I, J’.

In this case, the parity page 231 may store I^{th} parity Parity1 for data in the I^{th} block 201. In other words, the I^{th} parity Parity1 may be a result of performing the XOR operation on all the data pages 221 to 22(N−1) excluding the parity page 231 from among pages that constitute the I^{th} block 201.

Although FIG. 4 illustrates that in each of the plurality of blocks 201 to 20M of the memory array 230, the first to (N−1)^{th} data pages 221 to 22(N−1) are programmed and the remaining page, i.e., the N^{th} page 231, is programmed to a value that is obtained by performing the XOR operation and is stored in the operation module 254, the inventive concepts are not limited thereto. For example, when N pages are present in each of a plurality of blocks, an (N−B)^{th} page may be programmed to the value stored in the operation module 254. Here, ‘B’ denotes a natural number that is less than ‘N’.

In the memory device 120, stripes each consisting of the data pages 221 to 22(N−1) and the parity page 231 are present in the memory array 230. Thus, even when a plurality of the memory devices 120 is present, the data reliability of each of the plurality of memory devices 120 may be improved without being influenced by the other memory devices 120.

Furthermore, because the operation module 254 that performs the XOR operation may be included in each of the plurality of memory devices 120, a redundant array of independent disks (RAID) may be fabricated regardless of the total number of memory devices 120.

According to an embodiment of the inventive concepts, when parity is calculated to realize an RAID by using a plurality of the memory devices 120, the memory controller 110 outside the memory device 120 does not calculate parities of the plurality of memory devices 120. Thus, it is possible to prevent or inhibit an overhead from being loaded onto the memory controller 110, and to prevent or inhibit an external memory, e.g., a DRAM, from being accessed between the memory controller 110 and the plurality of memory devices 120.

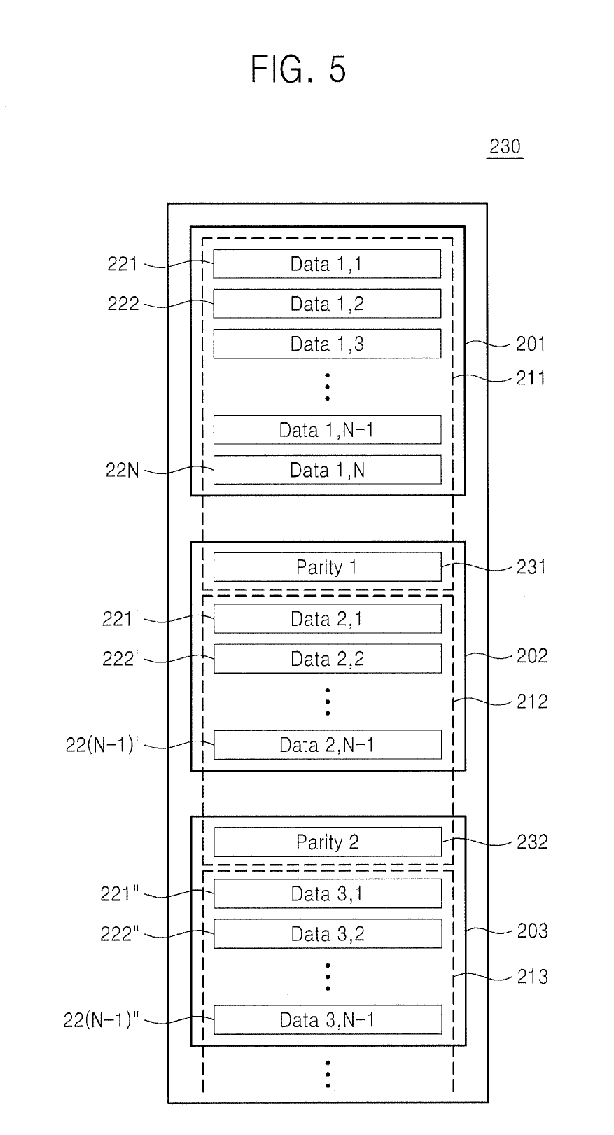

FIG. 5 is a diagram illustrating locations of parity pages stored, according to an embodiment of the inventive concepts. From among a plurality of blocks 201, 202, 203, . . . of a memory array 230, the first block 201 may include data pages 221 to 22N that constitute a first stripe 211. Here, ‘N’ denotes a natural number that is equal to or greater than ‘2’. The second block 202 may include a parity page 231 that constitutes the first stripe 211, and data pages 221′ to 22(N−1)′ that constitute a second stripe 212. The third block 203 may include a parity page 232 that constitutes the second stripe 212, and data pages 221″ to 22(N−1)″ that constitute a third stripe 213.

Specifically, first parity Parity1 for the data pages 221 to 22N of the first block 201 is stored in the second block 202, and a second parity Parity2 for the data pages 221′ to 22(N−1)′ of the second block 202 is stored in the third block 203. That is, parity for data pages of an I^{th} block is stored in an (I+1)^{th} block. However, FIG. 5 illustrates storage locations of parity pages according to an embodiment of the inventive concepts, and an order in which data pages and parity pages are arranged is not limited thereto.

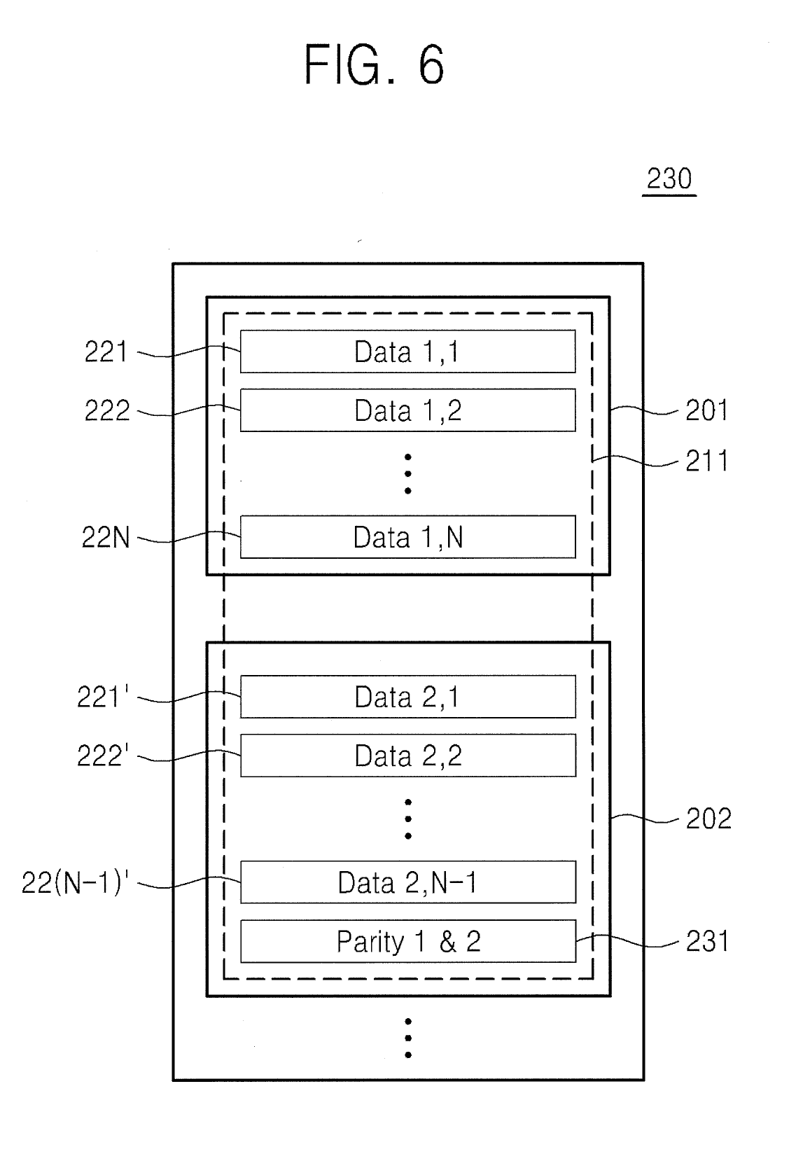

FIG. 6 is a diagram illustrating storage locations of parity pages according to another embodiment of the inventive concepts. Referring to FIG. 6, in a memory array 230, at least two blocks 201 and 202 from among a plurality of blocks may share a parity page 231. The parity page 231 constitutes one stripe 211.

Specifically, the first block 201 may consist of data pages 221 to 22N, and the second block 202 may consist of data pages 221′ to 22(N−1)′ and the parity page 231. Here, ‘N’ denotes a natural number that is equal to or greater than ‘2’.

In other words, one of the at least two blocks 201 and 202 of the memory array 230 may include the parity page 231 that corresponds to the stripe 211 and the other may include the data pages 221 to 22N that correspond to the stripe 211. However, the inventive concepts are not limited, and a block that includes a parity page, a block that shares the parity page, and the total number of blocks that may share one parity page are not limited.

For example, data pages each constituting at least three blocks from among a plurality of blocks may constitute one stripe and may share a parity page that constitutes one of the data pages, based on the attributes of the blocks or a purpose of operating the memory device 120 of FIG. 1.

The size of a stripe for generating parity is inversely proportional to data reliability. Thus, the structures of a parity page and data pages may vary based on a desired level of data reliability.

If the total number of pages that store parity is reduced, the total number of pages that may store other data may be increased.

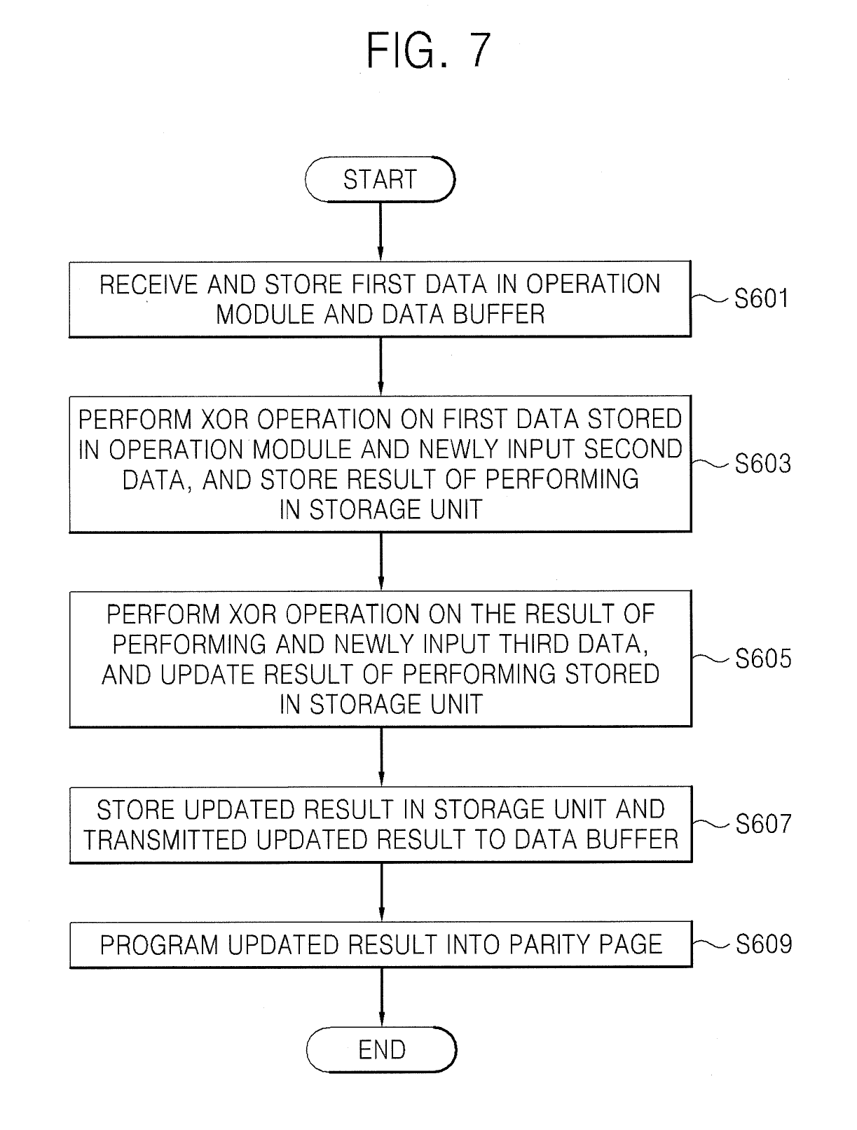

FIG. 7 is a flowchart illustrating a method of operating a non-volatile memory device, according to an embodiment of the inventive concepts. Specifically, FIG. 7 illustrates a process of receiving data from the outside, performing an operation on the data, and programming a result of the performing into a parity page.

Referring to FIGS. 1 and 7, the chip controller 250 may receive first data from the outside and store the first data in both the operation module 254 and the data buffer 252 (operation S601). The first data is input when the operation module 254 is empty. The operation module 254 cannot perform any operation using only the first data and may only store the first data.

After the first data is input, when second data is input to the chip controller 250, the chip controller 250 stores the second data in the operation module 254, and the operation unit 255 of the operation module 254 performs the XOR operation on the already stored first data and the second data. The operation unit 255 of the operation module 254 stores a result of the performing in the storage unit 256 of the operation module 254 (operation S603).

Operation S603 may be performed, for example, when a command to perform an operation on the second data is received from a host (not shown). Operation S603 may also be directly performed when the second data is received.

The chip controller 250 may store third data in the operation module 254 after the second data is input. The operation unit 255 of the operation module 254 may perform the XOR operation on the result of the performing, which is stored in the storage unit 256, and the third data. The operation unit 255 may use the result of the XOR operation to update the storage unit 256 of the operation module 254 (operation S605).

The chip controller 250 may receive a command from the host that specifies the total number of pieces of data that should be sequentially received to perform the XOR operation thereon. In other words, the command given from the host may be received from the memory controller 110.

For example, when 100 pieces of data constitute one stripe, the chip controller 250 may sequentially input the 100 pieces of the data to the operation module 254 and the data buffer 252. The chip controller 250 may program data stored in the data buffer 252 into the plurality of data pages 221 to 22N of FIG. 5, and the chip controller 250 may program parity, which is a result of performing the XOR operation on all or some of the data stored in the data buffer 252, into the parity page 231 of FIG. 5, in response to a request from the host. In other embodiments, a result of performing the XOR operation, i.e., parity, stored in the operation module 252 may be transmitted to the data buffer 252 (operation S607), and then, the parity transmitted via the data buffer 252 may be programmed into the parity page 231 (operation S609).

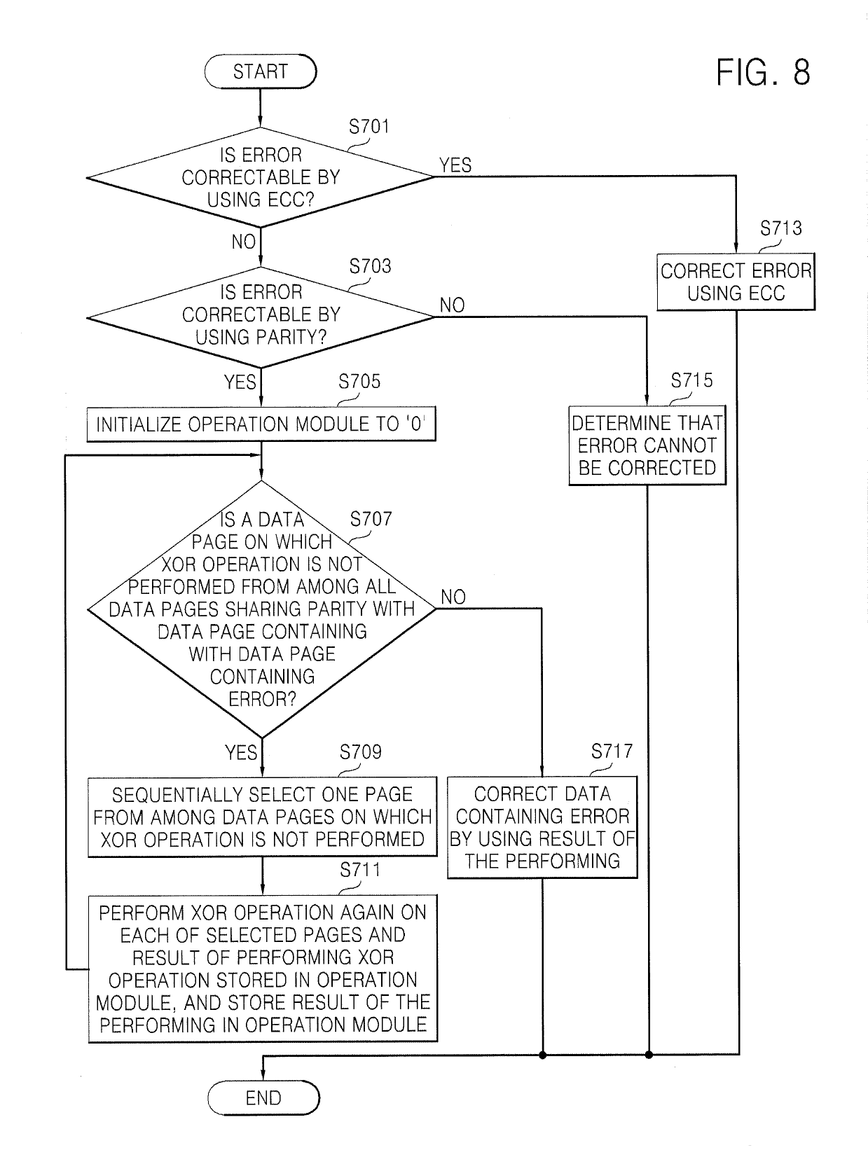

FIG. 8 is a flowchart illustrating a method of operating a non-volatile memory device, according to another embodiment of the inventive concepts. Specifically, FIG. 8 illustrates a process of correcting an error occurring in data stored in a data page.

Referring to FIGS. 1 and 8, when data having an error is detected from among data stored in pages constituting the memory array 230, the chip controller 250 determines whether the error can be corrected by using an error correction code (ECC) (operation S701). If the chip controller 250 determines in operation S701 that the error can be corrected using the ECC, the chip controller 250 corrects the error by using the ECC (operation S713).

If the chip controller 250 determines in operation S701 that the error cannot be corrected using the ECC, the chip controller 250 may determine whether the error can be corrected using a RAID that uses parity (operation S703).

If the chip controller 250 determines that the error cannot be corrected by adjusting the level of the RAID (operation S715), the method of FIG. 8 may terminate. If it is determined that the error can be corrected using parity, the chip controller 250 may initialize the operation module 254 to ‘0’ or the chip controller 250 may store first input data in the operation module 254 (operation S705).

The chip controller 250 may perform the XOR operation on data pages that share the same parity with the data page containing the error (i.e., the data pages that constitute one stripe, and a parity page), and the chip controller 250 may store a result of the performing in the operation module 254. The XOR operation may not be performed on the data page containing the error. In this case, the chip controller 250 may determine whether there is a data page on which the XOR operation is not performed from among all the remaining data pages that constitute the stripe (operation S707).

If the chip controller 250 determines in operation S707 that the XOR operation is performed on all the remaining data pages, then the data containing the error may be corrected using the result of the performing stored in the operation module 254 (operation S717).

If it the chip controller 250 determines in operation S707 that the XOR operation is not performed on all the remaining data pages, then the chip controller 250 may sequentially select a page from among the data pages on which the XOR operation is not performed (operation S709).

Then, the chip controller 250 may perform the XOR operation again on each of the selected pages and the result of the performing stored in the operation module 254, and the chip controller 250 may store a result of the performing in the operation module 254 (operation S711). Operations S707 to S711 may be repeatedly performed until the XOR operation is performed on all the data pages.

Then, when the XOR operation is performed on all the remaining data pages, the data containing the error may be corrected using the result of the performing stored in the operation module 254 (operation S717).

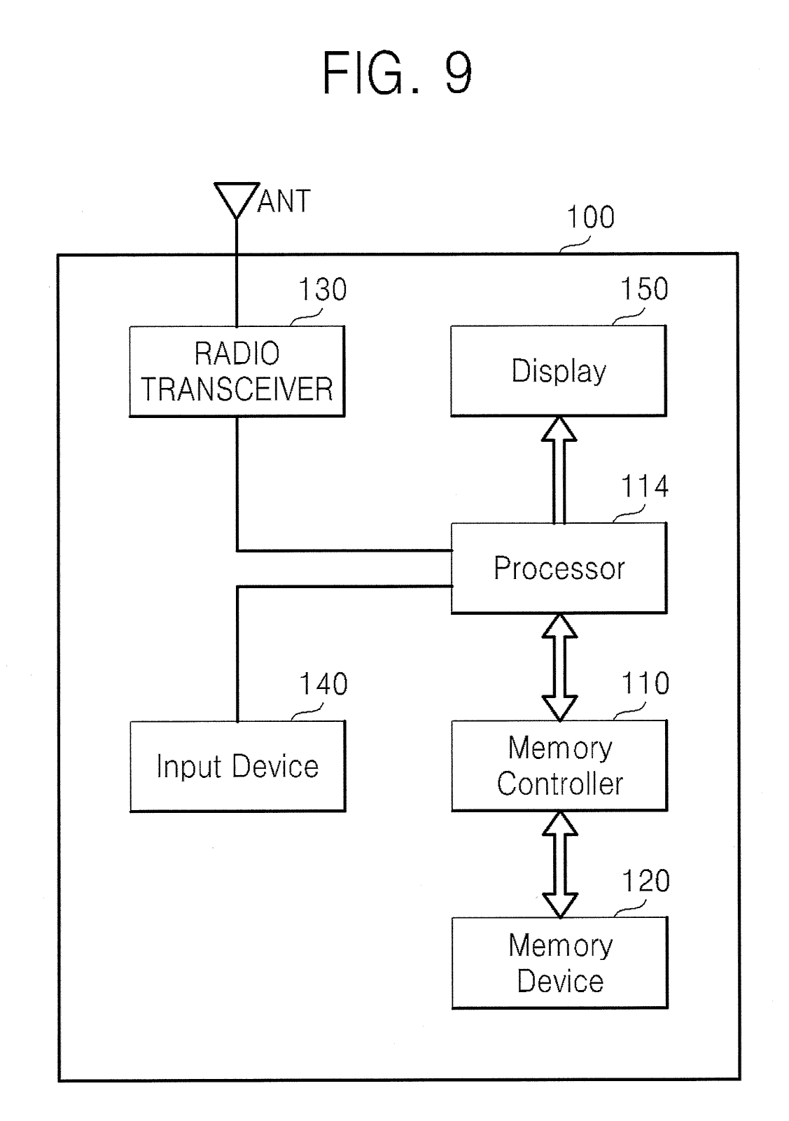

FIG. 9 through FIG. 12 are each diagrams of a nonvolatile memory system including the memory device according to some embodiments of the inventive concepts, respectively.

Referring to FIG. 9, the memory system 100 may be a cellular phone, a smart phone, a personal digital assistant (PDA) or a wireless communication device. The memory system 100 includes the semiconductor memory device 120 and a memory controller 110 controlling an operation of the memory device 120. The memory controller 110 may control a data write operation or data read operation of the semiconductor memory device 120 in response to a control of a processor 114. A program verifying operation may be included in a part of a program operation.

Data stored in the memory device 120 may be displayed through a display 150 in response to control of the processor 114 and the memory controller 110.

The radio transceiver 130 may transmit or receive a radio signal through an antenna ANT. For example, the radio transceiver 130 may convert a radio signal received through an antenna ANT into a signal that may be processed by the processor 114. Accordingly, the processor 114 may process a signal output from the radio transceiver 130 and transmit a processed signal to the memory controller 110 or the display 150. The memory controller 110 may program a processed signal in the memory device 120.

Moreover, the radio transceiver 130 may convert a signal output from the processor 114 into a radio signal and output a converted radio signal to an external device through an antenna ANT.

An input device 140 is a device that may input a control signal for controlling an operation of the processor 114 or data to be processed by the processor 114. The input device 140 may be a pointing device such as, for example, a touch pad and a computer mouse, a keypad or a keyboard.

The processor 114 may control an operation of the display 150 so that data output from the memory controller 110, data output from the radio transceiver 130 or data output from the input device 140 may be displayed through the display 150. According to an example embodiment, the memory controller 110 controlling an operation of the memory device 120 may be part of the processor 114 or a separate chip.

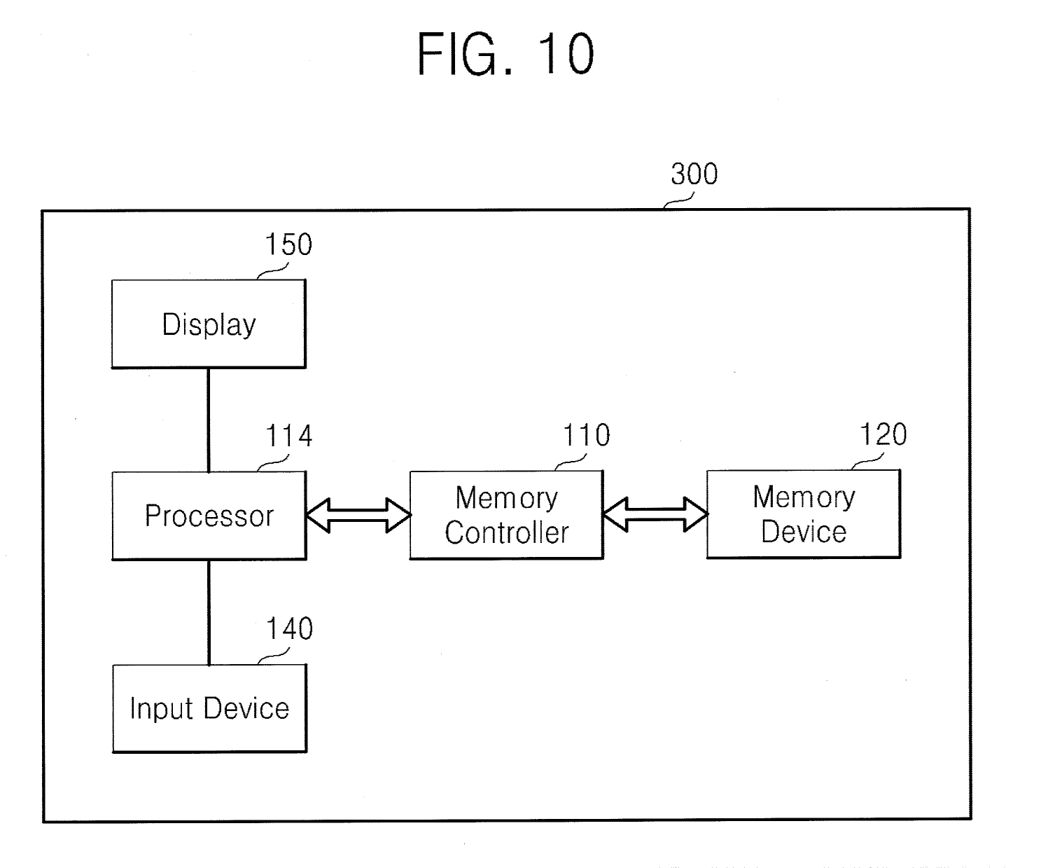

Referring to FIG. 10, the memory system 300 may be a PC, a tablet PC, a net-book, an e-reader, a personal digital assistant (PDA), a portable multimedia player (PMP), a MP3 player or a MP4 player. The memory system 300 includes the memory device 120, and a memory controller 110 controlling a data processing operation of the memory device 120.

The processor 114 may display data stored in the memory device 120 through a display 150, in response to data input through an input device 140. The input device 140 may be a pointing device such as, for example, a touch pad or a computer mouse, a keypad or a keyboard.

The processor 114 may control the overall operation of the memory system 300, and control the operation of the memory controller 110.

According to an example embodiment, the memory controller 110 controlling an operation of the memory device 120 may be a part of the processor 114 or a separate chip.

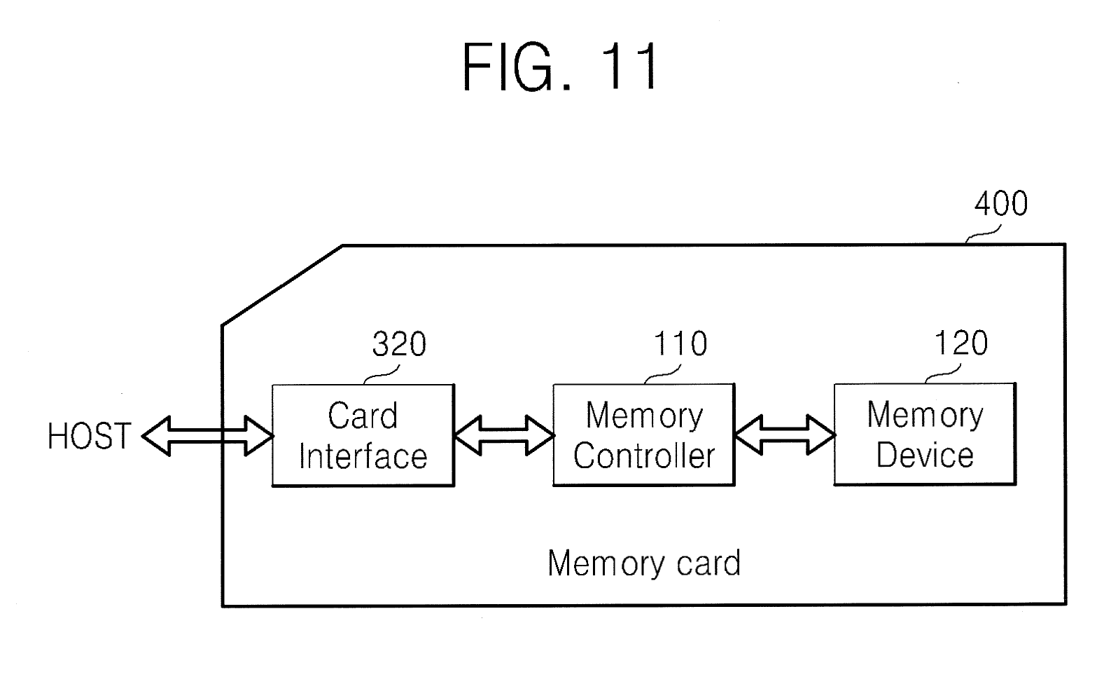

Referring to FIG. 11, the memory system 400 may be a memory card or a smart card. The memory system 400 includes the memory device 120, a memory controller 110 and a card interface 320.

The memory controller 110 may control all data exchange between the memory device 120 and the card interface 320. According to an embodiment of the inventive concepts, the card interface 320 may be a secure digital (SD) card interface or a multi-media card (MMC) interface, but the present inventive concepts are not restricted thereto.

The card interface 320 may server as an interface for data exchange between a host and the memory controller 110 based on a protocol of the host. According to an embodiment of the inventive concepts, the card interface 320 may provide a universal serial bus (USB) protocol or an inter-chip (IC) USB protocol. The card interface 320 may be hardware providing the protocol that the host uses, a software application installed on the hardware, or a signal transmission method.

When the memory system 400 is connected to the host such as, for example, a PC, a tablet PC, a digital camera, a mobile phone, a console video game hardware or a digital set-top box, the host may communicate with the memory device 120 through the card interface 320 and the memory controller 110.

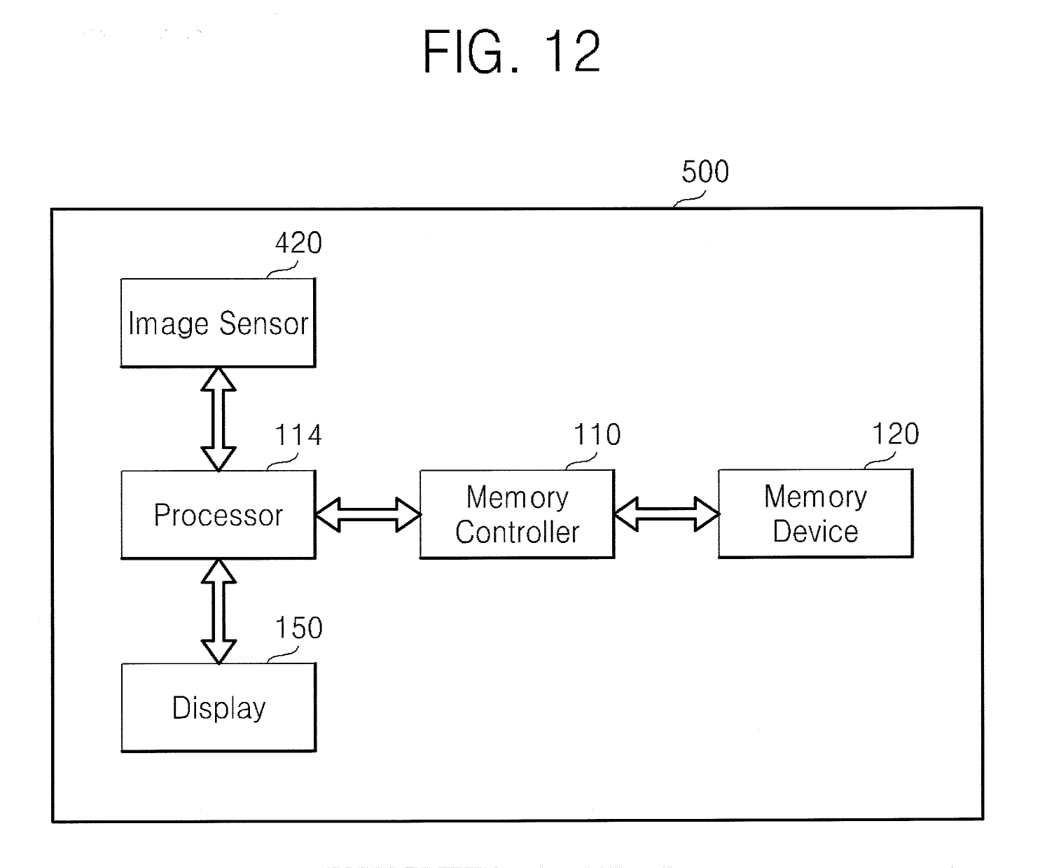

Referring to FIG. 12, the memory system 500 may be used for an image processing device such as, for example, a digital camera or a mobile phone equipped with a digital camera.

The memory system 500 includes the memory device 120, and a memory controller 110 controlling a data processing operation (e.g., a program operation, an erase operation or a read operation) of the memory device 120.

An image sensor 420 of the memory system 500 may convert a light signal to a digital signal, and transmit the converted digital signal to the processor 114 or the memory controller 110. The converted digital signal may be displayed through the display 150 or stored in the memory device 120 through the memory controller 110 in response to control of the processor 114.

Furthermore, data stored in the memory device 120 may be displayed through the display 150 in response to control of the processor 114 or the memory controller 110. According to at least one example embodiment, the memory controller 110 controlling an operation of the memory device 120 may be a part of the processor 114 or a separate chip.

According to an embodiment of the inventive concepts, an operation module that calculates and stores parity is included in each of memory devices. Thus, an RAID technique may be applied even to a memory card in which the total number of memory devices that operate independently is limited, thereby improving data reliability. Also, it is possible to prevent or inhibit a computational overhead from occurring when a plurality of memory devices are controlled by one memory controller, and to prevent or inhibit an external memory from being accessed when a plurality of memory devices are connected.

Furthermore, the size of a stripe that includes parity may be determined regardless of the total number of memory devices, based on the relationship between the size of the stripe and the desired level of data reliability. Accordingly, some data that cannot be corrected using an ECC may be corrected using parity, thus improving data reliability. If a desired level of data reliability is not high, a low-performance ECC engine may be used. Thus, it is possible to reduce manufacturing costs spent to develop and install a high-performance ECC engine.

Example embodiments having thus been described, it will be obvious that the same may be varied in some ways. Such variations are not to be regarded as a departure from the intended spirit and scope of example embodiments, and all such modifications as would be obvious to one skilled in the art are intended to be included within the scope of the following claims.

1. A non-volatile memory device comprising:
a memory array including at least one stripe, the at least one stripe including at least one parity page and at least one data page; and
a chip controller including,
an operation module configured to perform an operation on data input from the outside of the memory device, to store a result of the performing, and to program a result of the performing into the at least one parity page, and
a data buffer configured to store the input data and to program the input data into the at least one data page.

2. The non-volatile memory device of claim 1, wherein the chip controller is configured to store new data input from outside the memory device in the operation module and the data buffer, and the chip controller is configured to program only the new data stored in the data buffer into the at least one data page.

3. The non-volatile memory device of claim 1, wherein, if an operation command is received from a host, then the chip controller is configured to store a result of performing the operation on first data stored in the operation module and second data input after the first data is input in the operation module.

4. The non-volatile memory device of claim 3, wherein the first data and the second data are sequentially input from outside the memory device.

5. The non-volatile memory device of claim 1, wherein the memory array includes a plurality of blocks each including a plurality of pages, and each of the plurality of blocks includes one stripe.

6. The non-volatile memory device of claim 1, wherein,
the memory array includes a plurality of blocks, each of the plurality of blocks including a plurality of pages,
a first block of the plurality of blocks includes a data page of a first stripe, a second block of the plurality of blocks includes a parity page of the first stripe and a data page of the first stripe, and a third block of the plurality of blocks includes a parity page of a second stripe and a data page of a third stripe.

7. The non-volatile memory device of claim 1, wherein,
the memory array includes a plurality of blocks, each of the plurality of blocks including a plurality of pages, and
at least two blocks of the plurality of blocks share a data page and a parity page of one stripe.

8. The non-volatile memory device of claim 7, wherein one of the at least two blocks includes the parity page of the stripe, and the other of the at least two blocks includes the data page of the stripe.

9. The non-volatile memory device of claim 1, wherein the chip controller is further configured to:
initialize the operation module if an error occurs in a data page of the at least one data page of the memory array;
determine a stripe corresponding to the data page containing the error;
control the operation module to perform an operation on the at least one parity page of the determined stripe and on the data pages of the determined stripe that do not contain the error; and
store a result of the performing.

10. The non-volatile memory device of claim 9, wherein the chip controller is further configured to correct the data page containing the error based on the result of the performing.

11. The non-volatile memory device of claim 1, wherein the chip controller is further configured to:
determine at least one data page containing an error; and
correct the error in the at least one data page based on an error correction code.

12. A non-volatile memory system comprising:
the non-volatile memory device of claim 1; and
a memory controller for exchanging data with the non-volatile memory device and providing a command received from a host to the non-volatile memory device.

13.-17. (canceled)

18. A non-volatile memory device, comprising:
a memory array including at least one set of data pages and at least one parity page for the at least one set of data pages; and
an engine configured to calculate parity generated by the at least one set of data pages and to store parity in the at least one parity page.

19. The non-volatile memory device of claim 18, further comprising:
a chip controller configured to,
perform an operation on data input from outside the memory device;
store the input data in a data buffer; and
program the input data into the at least one data page.

20. The non-volatile memory device of claim 19, wherein the chip controller is further configured to:
determine a set of data pages corresponding to a data page containing an error;
perform an operation on the at least one parity page of the determined set of pages and on the data pages of the determined set of pages that do not contain the error;
store a result of the performing; and
correct the error based on the result of the performing.
